(19) United States
(12) Patent Application Publication
(10) Pub. No.: US 2009/0004362 A1
(43) Pub. Date: Jan. 1, 2009

(54) MEAT PRODUCTS

(75) Inventors: Donald W. Hoppe, Falls City, NE (US); Devon F. Pence, Kechi, KS (US); Roger Wilson, Plattsmouth, NE (US)

Correspondence Address: CARGILL, INCORPORATED, LAW/24, 15407 MCGINTY ROAD WEST, WAYZATA, MN, 55391, US

(73) Assignee: Cargill, Inc., Wayzata, MN (US)

(21) Appl. No.: 11/768,692

(22) Filed: Jun. 26, 2007

(51) Int. Cl. A23L 1/31; A22C 7/00

(52) U.S. Cl. 426/641; 426/513

(57) ABSTRACT

A meat product may include a plurality of whole muscle meat portions that each have substantially opposite end faces. The plurality of whole muscle meat portions may be consecutively disposed such that respective adjacent end faces of the whole muscle meat portions substantially face each other and have at least some regions that are attached. The meat product may have a substantially elongated configuration in a direction extending from a first whole muscle meat portion of the consecutively disposed whole muscle meat portions to a last whole muscle meat portion of the consecutively disposed whole muscle meat portions.

### FIELD

The present invention relates to meat products, and devices and methods for making meat products. In particular, the present invention relates to meat products configured for slicing.

Meat products configured for human consumption come in a variety of forms. More specifically, a variety of cooked meat products may be configured to be sliced, for example, at a deli counter or prior to packaging for purchase by consumers. Conventional meat products for slicing typically include either a single, whole muscle meat portion, a meat product formed from one or more whole muscle meat portions, which may, for example, be stacked in a substantially vertical arrangement wherein lateral surfaces of the meat portions overlap each other, as will be described further below, or a meat product in the form of a slicing log formed from a restructured (e.g., ground) emulsion of several meat portions.

The term “slicing log” may be used to refer to a product that is longer than it is wide, for example, at its widest point.

FIG. 1 schematically depicts a conventional single, whole muscle meat product 100. The meat product 100 comprises a single, whole muscle piece of meat and is typically enclosed in a wrapping, which in the exemplary embodiment of FIG. 1 is a netting 110, but can also be a casing or other suitable wrapping. Any type of meat may be used for the meat product 100, including, for example, bovine, porcine, and poultry. Nonlimiting examples of the meat product 100 include roast beef, turkey breast, ham, etc. Such meat products 100 are typically found and sliced at a deli counter and are of relative high quality in comparison to slicing logs formed of an emulsion of restructured and/or ground meat, nonlimiting examples of which include salamis, bologna, sausages, etc. Slicing logs, however, also may be formed from an emulsion of ground turkey, chicken, beef, pork, and/or any other type of meat. Slicing logs also may be found and sliced at a deli counter, or may be presliced and the slices packaged as a group prior to distribution for purchase by consumers.

FIG. 2 schematically depicts another conventional meat product 200 configured for slicing. The meat product 200 comprises two whole muscle meat portions 201 and 202 that are stacked substantially vertically, in other words, one on top of the other, such that lateral exterior surfaces of the whole muscle meat portions substantially abut each other, within an enclosure 210. In other words, the whole muscle meat portions 201 and 202 overlap each other along a length of the meat portions 201 and 202. The meat product 200 is cooked and configured to be sliced in a direction substantially perpendicular to a direction of elongation (e.g., a longitudinal axis) of the meat product 200, for example, as illustrated in the cross-section shown in FIG. 2. As such, when sliced, the meat product 200 yields slices that include meat from the two whole muscle meat portions 201 and 202. Ham slices often are obtained from slicing a meat product in the form of meat product 200.

Those with skill in the art will appreciate that the meat product 200 comprising two whole muscle meat portions 201 and 202 is exemplary and that similar meat products may be made of more than two whole muscle meat portions, wherein the plurality of whole muscle meat portions are positioned relative to each other such that upon slicing the meat product in the direction so as to obtain the cross-section shown in FIG. 2, the slices typically contain meat from more than one whole muscle meat portion. Further, some meat products, such as, for example, prosciutto ham, which is dry cured and not cooked, may be formed from a plurality of muscles chiseled away from a bone-in ham, such that slices obtained therefrom include multiple muscles (i.e., meat from a plurality of differing muscles of the chiseled ham).

The meat products shown in FIGS. 1 and 2 typically have a length I of not longer than about 1.5 feet.

When slicing a meat product having a configuration similar to the meat product 200 and/or a slicing log made from an emulsion of restructured and/or ground meat portions, the slices obtained will contain meat from more than one whole muscle meat portion. In other words, when sliced in a direction substantially perpendicular to a direction of elongation of the meat product (or, for example, slicing in planes substantially parallel to planes that are tangential to the ends of the meat product), the slices will contain meat from more than one whole muscle meat portion. In particular, a meat product configured like the meat product 200 will yield slices that contain meat from two whole muscle meat portions 201 and 202, and a slicing log formed from an emulsion of ground meat will yield slices that contain meat from a plurality of whole muscle meat portions.

As such, the quality of the sliced meat product may be low in comparison to slices obtained from a single, whole muscle meat portion, such as that described with reference to FIG. 1, for example. Moreover, the aesthetic appearance of slices that contain meat from more than one whole muscle meat portion may be less appealing to consumers. For example, slices obtained from meat products that are formed from positioning (e.g., stacking) a plurality of whole muscle meat portions substantially along lateral faces of those meat portions may show varying directions of grain and/or voids due to areas where adjacent meat portions did not attach (e.g., bind) together during cooking. Also, obtaining consistent slices, for example, in terms of aesthetic appearance, size, and/or taste, from a meat product like meat product 200 or from a slicing log formed from restructured and/or ground meat may pose problems due to the lack of consistency of the composition of those meat products along the length and width of the product.

On the other hand, slicing a meat product in the form of a single whole muscle meat portion, as described with reference to FIG. 1, may yield higher quality slices, in terms of aesthetic appearance and/or the overall product cut and taste. However, due to yield loss and other inefficiencies associated with slicing single whole muscle meat products, it generally is not practical to slice such meat products for prepackaging and distribution to retail outlets. For example, in their current form as schematically represented in FIG. 1, meat products in the form of a single whole muscle meat portion typically have a relatively high yield loss for obtaining uniform, useable (e.g., saleable) slices because the end portions of the meat product are generally discarded and not provided in sliced form to consumers. Due to the relatively high radius of curvature and irregular shape of the end portions of such conventional single whole muscle meat products, as well as the gripping of one end portion by conventional slicing equipment, relatively large amounts of those end portions cannot be used for slicing and supplying to consumers, either as prepackaged slices or as deli slices. More specifically, some conventional slicing devices include a claw or other grasping mechanism that holds on to one end portion of a conventional meat product (e.g., meat product 100) and at least about 18 mm (0.71 in.) of that end portion therefore cannot be sliced. Further, a portion of the end of the meat product opposite to where the slicing equipment grabs also may not be used for slices supplied to consumers because of irregularities and nonuniformity in the slices obtained from that portion. Each of the discarded end portions can have a thickness ranging from about 0.5 inches to about 2.5 inches. Consequently, conventional single whole muscle meat products yield from about 70% to about 90% of uniformly thick slices, for example, for slice thicknesses ranging from about 0.039 in. (1 mm) to about 0.157 in. (4 mm). Moreover, slicing such meat products and prepackaging the slices for distribution to retail outlets can be inefficient because of the time and labor involved with having to load each single whole muscle meat portion onto slicing equipment to obtain a desired number of slices.

It may therefore be desirable to provide a meat product that has an increased yield of substantially uniformly thick slices as compared to conventional meat products. It also may be desirable to provide a meat product that yields slices containing meat from a single whole muscle meat portion and that is configured to do so in a relatively efficient manner, for example, upon slicing the meat product for prepackaged slices retail distribution. It also may be desirable to provide a sliceable meat product that is configured to provide substantially consistent slices in terms of overall dimension, shape, and content of each of the slices.

In addition, it may be desirable to provide a meat product that is formed from more than one whole muscle meat portion and yields slices that have a relatively high quality, for example, slices that have an aesthetically pleasing (e.g., consistent) appearance and/or a better cut or taste, as compared to conventional meat products formed from more than a single whole muscle.

### SUMMARY

The present invention may satisfy one or more of the above-mentioned desirable features. Other features may become apparent from the description which follows.

In accordance with various exemplary embodiments of the present teachings, a meat product may include a plurality of whole muscle meat portions that each have substantially opposite end faces. The plurality of whole muscle meat portions may be consecutively disposed such that respective adjacent end faces of the whole muscle meat portions substantially face each other and have at least some regions that are attached. The meat product may have a substantially elongated configuration in a direction extending from a first whole muscle meat portion of the consecutively disposed whole muscle meat portions to a last whole muscle meat portion of the consecutively disposed whole muscle meat portions.

In accordance with various exemplary embodiments of the present teachings, a method of making a meat product may include consecutively loading a plurality of whole muscle meat portions into an enclosure such that respective adjacent end faces of the whole muscle meat portions substantially face each other Loading the plurality of whole muscle meat portions into the enclosure may form a meat product having a substantially elongated configuration in a direction extending from a first whole muscle meat portion of the plurality of whole muscle meat portions to a last whole muscle meat portion of the plurality of whole muscle meat portions.

According to various exemplary embodiments of the present teachings, a meat product may include a whole muscle meat slicing log that is configured to yield at least about 90% of meat slices having substantially uniform thicknesses.

These and other features of the present teachings are set forth herein. In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

### BRIEF DESCRIPTION OF THE DRAWINGS

The accompanying drawings, which are incorporated in and constitute a part of this specification, illustrate exemplary embodiments and together with the description, serve to explain various principles. The skilled artisan will understand that the drawings, described below, are for illustration purposes only. The drawings are not intended to limit the scope of the present teachings in any way. In the drawings,

FIG. 1 is a perspective view of an embodiment of a conventional meat product;

FIG. 2 is a cross-sectional perspective view of another embodiment of a conventional meat product;

FIG. 3 is a schematic perspective view of an exemplary embodiment of a meat product according to an aspect of the present teachings;

FIG. 4 is a schematic cross-sectional view of the meat product of FIG. 3 taken from section line IV-IV in FIG. 3;

FIG. 5 is a schematic perspective view of an exemplary embodiment of a device for making a meat product in accordance with various aspects of the present teachings;

FIG. 6 is a schematic cross-sectional view of an exemplary embodiment of a method of placing whole muscle meat portions into the device of FIG. 3 according to various aspects of the present teachings;

FIG. 7 is a schematic cross-sectional view of an exemplary embodiment of a method of loading a plurality of whole muscle meat portions via the device of FIG. 3 according to various aspects of the present teachings;

FIG. 8 is a schematic cross-sectional view of an exemplary embodiment of a meat product formed according to various aspects of the present teachings;

FIG. 9 is a schematic perspective view of an exemplary embodiment of a meat product according to various aspects of the present teachings;

FIG. 10 is a cross-sectional view of the meat product of FIG. 9 taken from section line X-X in FIG. 9;

FIG. 11A is a perspective view of an exemplary embodiment of a mold defining an enclosure in accordance with various aspects of the present teachings; and

FIG. 11B is a perspective view of another exemplary embodiment of a mold defining an enclosure in accordance with various aspects of the present teachings.

### DESCRIPTION

Reference will now be made in detail to various exemplary embodiments examples of which are illustrated in the accompanying drawings. Wherever possible, the same reference numbers will be used throughout the drawings to refer to the same or like parts.

In accordance with the present teachings, various exemplary embodiments may include a meat product that is made from a plurality of whole muscle meat portions that are consecutively disposed in a substantially end-to-end arrangement. That is, each whole muscle meat portion has a substantially elongated configuration with substantially opposite end faces and when disposed consecutively, the respective adjacent end faces of consecutive meat portions substantially face each other. The meat product may be a cooked meat product, and at least some regions of the respective adjacent end portions may be attached (e.g., fused) together. In this way, the meat product, while formed from a plurality of individual whole muscle meat portions, nonetheless forms an integral, unitary product. The meat product may have a substantially elongated configuration in a direction extending from a first whole muscle meat portion of the consecutively disposed whole muscle meat portions to a last whole muscle meat portion of the consecutively disposed whole muscle meat portions.

As used herein, whole muscle meat portions may refer to a variety of types of meat, wherein the portion is from a cut of a single muscle and kept in its bulk form and not restructured (e.g., ground). Types of whole muscle meat portions may include bovine, porcine, or poultry; the invention is not intended to be limited by meat type and therefore can include any type of meat, including exotic species, such as, for example, rabbit, deer, bison, quail, and/or ostrich, for example. Further, meat products in accordance with exemplary embodiments of the present teachings can include so-called “natural” and/or “organic” meat products, and/or meat products comprising whole muscle meat portions that are not “natural” or “organic,” but rather include meat products from a variety of sources. “Natural” and/or “organic” meat products as used herein may include, for example, products in conformance with the U.S. Department of Agriculture's (USDA) standards for natural, such as, for example, as defined in the USDA's “Food Standards and Labeling Policy Book.” In the case of exotic species, “natural” and/or “organic” may refer to products in conformance with U.S. Food and Drug Administration (FDA) standards.

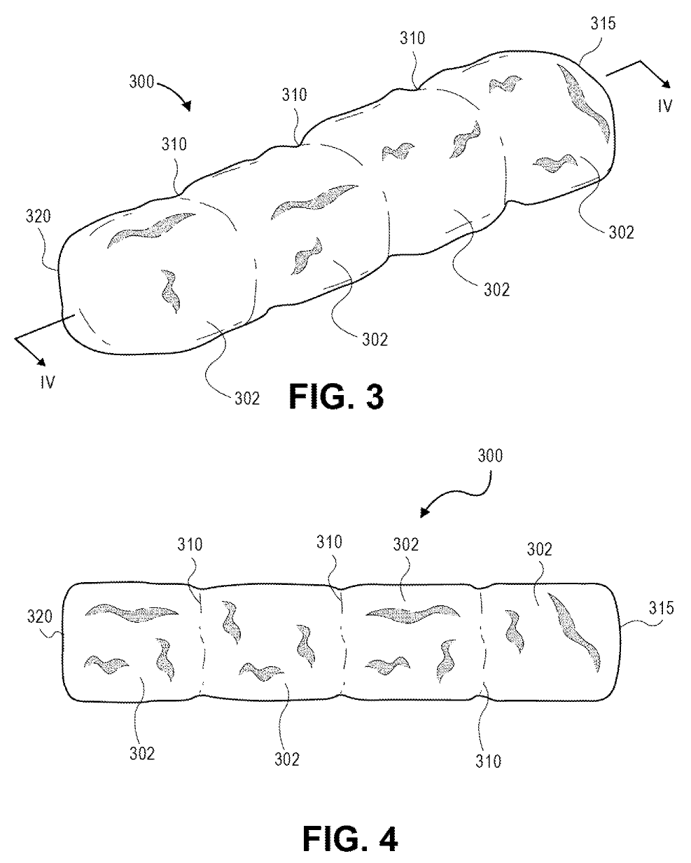

An exemplary embodiment of a meat product in accordance with aspects of the present teachings is schematically depicted in FIGS. 3 and 4. FIG. 3 illustrates a perspective view of a meat product 300 and FIG. 4 illustrates a cross-sectional view of the meat product 300 taken through section IV-IV of FIG. 3. In the exemplary embodiment of FIGS. 3 and 4, the meat product 300 includes a plurality of whole muscle meat portions 302 each having a substantially elongated configuration and substantially opposite end faces. The whole muscle meat portions 302 may be disposed consecutively one after the other in an end-to-end arrangement, as shown. Thus, respective adjacent end faces of consecutively disposed meat portions 302 substantially face and abut each other. As illustrated in FIGS. 3 and 4, respective adjacent end faces of the whole muscle meat portions 302 may be joined together at least in some regions thereof to form joints 310 where the adjacent end faces meet. The joints 310 depicted in FIGS. 3 and 4 are illustrative and representative only. Joints formed by the attached regions of adjacent end faces may be more or less apparent in an actual meat product according to the present teachings. In various exemplary embodiments, the joints 310 may have a thickness (e.g., in the direction of elongation of the meat product) ranging from about 1 in. to about 3 in.

When referring to an end face of a whole muscle meat portion, it should be understood that the end faces include the faces of the whole muscle meat portion that substantially flank the length of the whole muscle meat portion, with each end face facing substantially opposite directions to each other when the whole muscle meat portion is laid out lengthwise. It should be understood that although some exemplary embodiments shown and described herein may depict end faces as having a substantially planar surface, in reality, such end faces may have irregular surface profiles.

The meat product 300 may be elongated in a direction from a free end 315 of a first whole muscle meat portion 302 of the plurality of whole muscle meat portions 302 to a free end 320 of the last whole muscle meat portion 302 of the plurality of whole muscle meat portions 302. The term free end as used herein may be used to refer to an end face of a whole muscle meat portion that does not lie adjacent to a consecutively disposed whole muscle meat portion. The meat product 300 may form a slicing log that is configured to be sliced in a direction substantially perpendicular to the direction of elongation of the meat product 300 (e.g., substantially perpendicular to a direction of the length of the meat product 300 or, in other words, substantially parallel to a plane tangential to either of the ends 315 or 320). Depending on the whole muscle meat portions 302 used, the slicing may be either substantially with the grain of the meat or at an angle to the grain.

When sliced accordingly, most of the slices obtained from the meat product 300 will contain meat from one of the whole muscle meat portions 302. In other words, although individual slices obtained from the meat product 300 may contain meat from differing ones of the whole muscle meat portions 302, most of the individual slices will not contain meat from more than one of the whole muscle meat portions 302. It is expected that only a few slices that are obtained from regions proximate the joints 310 will contain meat from more than one of the whole muscle meat portions 302 (e.g., meat from two adjacent whole muscle meat portion 302). By way of example, not more than about 20% of the slices obtained from slicing the entire meat product 300, for example, into slices ranging in thickness from about 0.039 in. (1 mm) to about 0.157 in. (4 mm), will contain meat from more than one of the plurality of whole muscle meat portions 302. In various exemplary embodiments, from about 2% to about 20%, for example, from about 10% to about 15%, of the slices obtained from the meat product will contain meat from more than one of the plurality of whole muscle meat portions 302.

The meat product 300 shown in the exemplary embodiments of FIGS. 3 and 4 is made of four whole muscle meat portions 302. It should be understood, however, that the plurality of whole muscle meat portions can include any plural number of whole muscle meat portions. By way of example only, and not limitation, in various exemplary embodiments, a meat product may include from two to eight whole muscle meat portions. In various exemplary embodiments, the overall length of a meat product may be based, for example, on the number of whole muscle meat portions used. By way of example, exemplary embodiments of meat products in accordance with the present teachings may range from about 2 feet to about 5 feet in length, for example, from about 3 feet to about 4 feet. In accordance with various exemplary embodiments, the overall length of the meat product may be based on the size, for example, the length, of cook racks used for cooking the product.

The weight of a meat product in accordance with various exemplary embodiments may be based on a variety of factors, including, for example, the circumference of the net/casing, the type of meat, and the number of whole muscle portions used to form the meat product. By way of nonlimiting example, an upper weight may be about 60 pounds, for example, if the process largely relies on human beings to lift the product. Meat products of larger weight may also be used, however, when using processes that are in large part automated.

By providing a relatively elongated configuration in the direction of consecutively disposed whole muscle meat portions 302, the meat product 300 may have an increased yield of substantially uniformly thick slices when sliced substantially perpendicular to the elongated direction in comparison to the yield of conventional single whole muscle meat products. For example, about 90% or more, for example, from about 90% to 95%, of the meat product 300, and other meat products described herein in accordance with the present teachings, may yield substantially uniformly thick slices. These yields may apply, for example, for average thicknesses of the slices ranging from about 0.039 in. (1 mm) to about 0.157 in. (4 mm), for example. This increased slice yield of the meat product 300 may result from the increase in the overall length of the meat product and/or from the increase in the uniformity of the dimension and shape of the meat product along its length as compared to the nonuniformly shaped free end portions, e.g., end portions 315 and 320, and the tendency of the joints 310 to fuse together to create a substantially uniform profile along the length of the meat product 300.

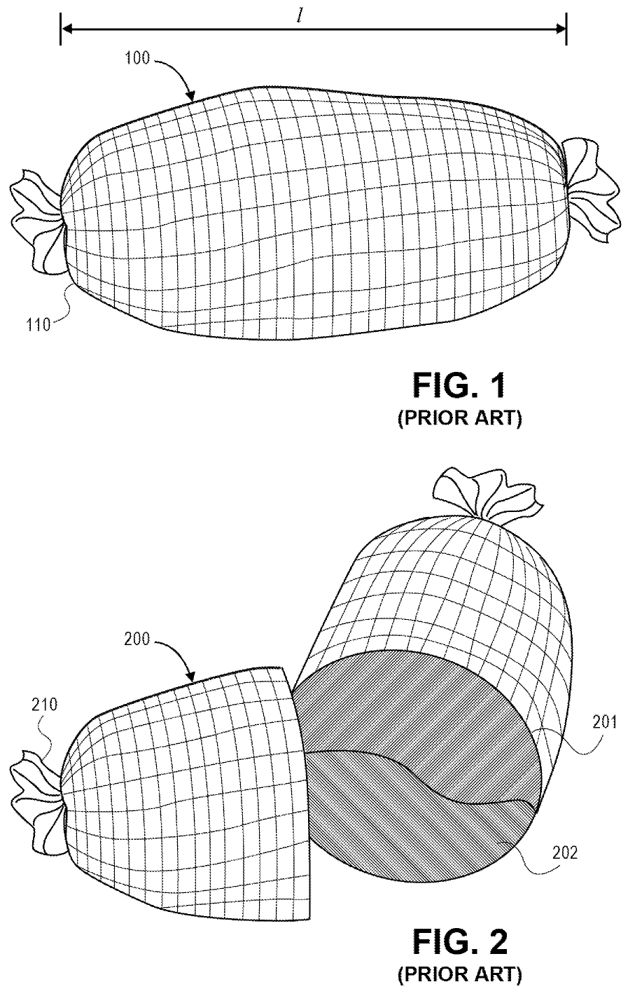

Moreover, the meat product 300 may provide a slicing log that is well-suited for slicing into a plurality of slices to be pre-packaged and shipped to retail distribution outlets for purchase by consumers. That is, the relatively large length of the meat product 300 may promote efficiency during a slicing process because more slices can be obtained from the meat product 300 before having to reload the slicing equipment with a new meat product (e.g., slicing log). In contrast, slicing of conventional meat products to obtain slices containing meat from a single whole muscle may not be practical since conventional meat products that yield slices containing meat from a single whole muscle meat portion require frequent reloading of slicing equipment due to their relatively small overall length (e.g., length I shown in FIG. 1).

Various techniques may be employed to make a meat product in accordance with exemplary embodiments of the present teachings, such as, for example, the meat products described above. In general, a plurality of raw whole muscle meat portions may be consecutively disposed in an end-to-end fashion (e.g., such that respective adjacent end faces of consecutive meat portions substantially face each other) in an enclosure. The loading may be accomplished in a variety of ways, including manual loading of the meat portions and/or automated loading. By way of example, loading equipment, such as, for example, breech loaders, presses, and/or any other types of loading equipment, including for example, loading equipment relying on hydraulic and/or pneumatic piston loading mechanisms, with which those having skill in the art would be familiar, may be used to load the plurality of whole muscle meat portions in an enclosure in an end-to-end manner. Loading equipment that may be used in conjunction with exemplary methods disclosed herein includes, but is not limited to, Smeco presses marketed by Smeco Industries, WM™ Netter Model TN™ 2001WM marketed by TipperTie®, and the Hamax 800 marketed by Wolf-tec, Inc., Reelpak Stuffers made by Teepak, LLC.

As used herein, an enclosure may refer to a structure that entirely encloses the plurality of consecutively disposed raw whole muscle meat portions or that partially encloses the plurality of consecutively disposed raw whole muscle meat portions. Examples of suitable enclosures include, but are not limited to, wrappings, such as for example, casings and nettings, and molds. By way of nonlimiting example only, suitable enclosures may include a variety of nettings, casings, and/or other wrapping made and/or marketed by, for example, Vista International Packaging, LLC, Jif-Pak Manufacturing, Inc., Viskase Companies, Inc., ZIP-net, Inc., Kalle, REELpak®, TipperTie, Inc., and Sealed Air Corp., including, for example, Cryovac® packaging products, to name a few. Suitable enclosures in accordance with the present teachings also may include any structure or combination of structures that provide a sufficient pressure on exterior surface portions of the raw whole muscle meat portions (e.g., in the lengthwise and lateral directions) to maintain respective adjacent end faces of consecutively disposed whole muscle meat portions substantially facing each other without substantially overlapping on lateral faces thereof. In other words, the structure or structures defining the enclosure may provide sufficient pressure on the plurality of raw whole muscle meat portions to maintain the meat portions in an end-to-end arrangement.

Once loaded in a desired end-to-end manner in an enclosure, the enclosure containing the plurality of raw or partially cooked whole muscle meat portions (e.g., the raw or partially cooked meat product) may be subjected to a cooking process. During the cooking process, the respective adjacent end faces of consecutively disposed whole muscle meat portions may attach (e.g., fuse) together at least at some regions. As discussed above with reference to FIGS. 3 and 4, the attaching together of the respective adjacent end faces forms joints at those regions and the plurality of whole muscle meat portions thereby join together to form a unitary meat product.

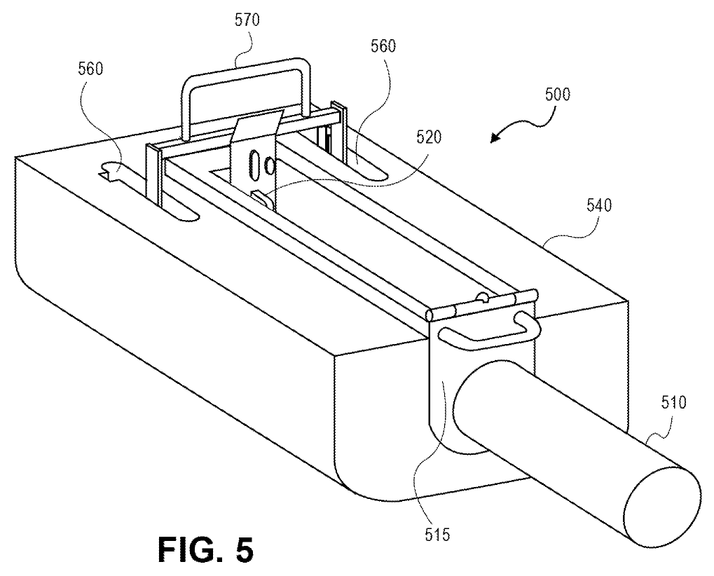

Referring now to FIGS. 5-9, exemplary embodiments of a technique and devices for forming a meat product in accordance with exemplary embodiments of the present teachings are illustrated. As noted above, an exemplary technique for making a meat product in accordance with the present teachings may include the utilization of automated loading equipment. An exemplary schematic embodiment of a loading device is illustrated in the partial perspective view of FIG. 5. As illustrated in FIG. 5, a so-called breech loader 500 may comprise a housing 540 that defines a recess in which a removable chamber 515 may be received. A loading tube (e.g., horn) 510 may extend from an end of the chamber 515 and may be in flow communication with the interior of the chamber 515. The chamber 515 may be provided with a cover (not shown) that has a handle 520 configured to be grasped by a user to lift the cover upward to provide access to the interior of the chamber 515. A latch 570 may slide along recesses 560 formed in the housing 540 on either side of an end portion of the chamber 515 opposite the end portion from which the loading tube 510 extends. The latch 570 may be configured to hinder opening the cover when the loader 500 is in use.

As noted above, the entire chamber 515 with the loading tube 510 attached may be removable from the housing 540. This may permit a size of the chamber 515 and loading tube 510 to be changed to accommodate differing sizes of meat portions desired to be loaded. It is also contemplated that the loading tube 510 may be removable from the chamber 515 so as to provide various combinations of loading tube size and chamber size, as desired. Various exemplary parameters to consider when selecting sizes for the chamber, loading tube, and an enclosure for loading the meat portions into are set forth in more detail below with reference to exemplary embodiments.

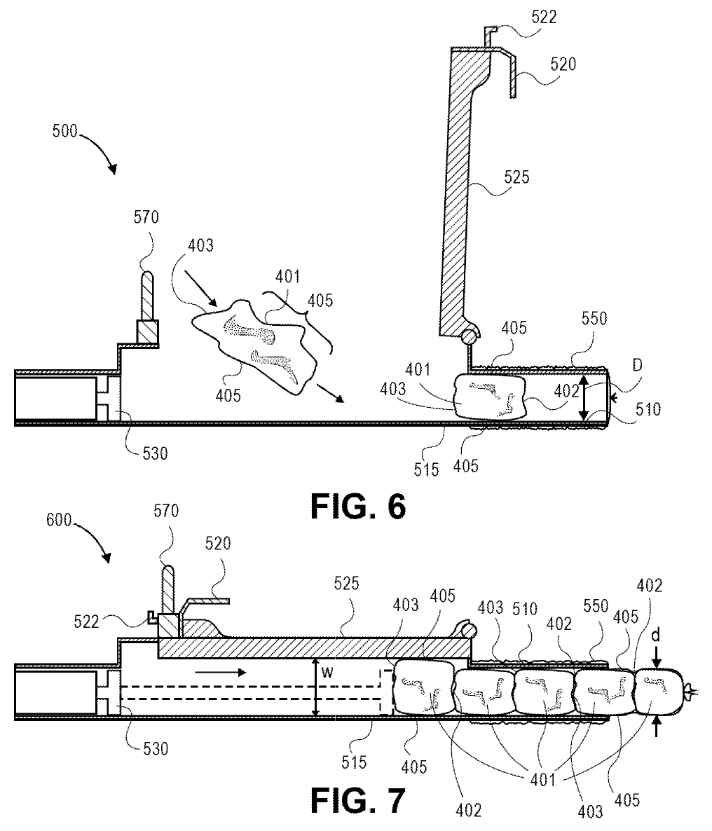

Use of the loader 500 to make a meat product in accordance with various exemplary embodiments of the present teachings will now be described with reference to the cross-sectional views of the loader 500 in FIGS. 6 and 7. With the latch 570 in a retracted position (e.g, moved to the ends of the slots 560 farthest from the loading tube 510 in FIG. 5), the cover 525 may be lifted using the handle 520 and placed in a position to provide access to an interior of the chamber 515. A plurality of individual raw or partially cooked whole muscle meat portions 401 (which may be fresh or frozen), which have substantially opposite end faces 402 and 403 and a lateral exterior surface 405 between the end faces 402 and 403, may then be placed into the chamber 515. The plurality of whole muscle meat portions 401 may be loaded in the chamber 515 in a consecutive, end-to-end manner. In the exemplary embodiment shown, at least some of the whole muscle meat portions 401 may be placed within the loading tube 510. In an alternative method, however, all of the meat portions 401 can be loaded into the chamber 515.

In various exemplary embodiments, each of the plurality of whole muscle meat portions 401 may be of the same meat type. However, it is considered as within the scope of the present teachings that at least one of the plurality of whole muscle meat portions 401 is of a meat type that differs from a meat type of at least one other of the plurality of whole muscle meat portions 401.

After a desired number of raw or partially cooked whole muscle meat portions 401 are loaded into the chamber 515 and/or loading tube 510, the cover 525 may be closed and the latch 570 may be moved along the recesses 560 and into engagement with a lip 522 provided on the cover 525. In this position, the latch 570 may hinder lifting of the cover 525 into an open position. The lip 522 may substantially prevent the latch 570 from moving along the recesses 560 and out of engagement to prevent the lifting of the cover 525.

Once the cover 525 is closed and the latch 570 is in the position shown in FIG. 7, the loader 500 may be actuated. Upon actuation, a piston 530, which in various exemplary embodiments may be a hydraulic or pneumatic piston 530, advances along the chamber 515 as shown by the dotted line in FIG. 7. The piston 530 pushes on the end 403 of the last whole muscle meat portion 401 consecutively disposed in the chamber 515 to force the plurality of whole muscle meat portions 401 out of the chamber 515 and loading tube 510, and into the enclosure of a wrapping 550 placed over the loading tube 510. The wrapping 550 may be positioned on the loading tube 510 in various manners, including manually or by other automated equipment known to those skilled in the art.

The wrapping 550 may be chosen from a variety of types of wrappings, including, for example, casings, nettings, and/or any suitable wrapping known to those skilled in the art and used for enclosing meat products of various kinds. Nonlimiting examples of casings may include, but are not limited to, barrier, non-barrier, color transfer, non-color transfer, seasoning transfer, non-seasoning transfer, shrink, non-shrink, and/or any other type of casing that may be suitable for use in packaging and making meat products. Nonlimiting examples of nettings may include, but are not limited to, elastic, non-elastic, fixed circumference, color transfer, non-color transfer, seasoning transfer, non-seasoning transfer, cotton-based, polyester or other synthetic based, stocking style, casing style, open weave, and/or any other type of netting that may be suitable for use in packaging and making meat products. The various wrappings may include a variety of treating mechanisms, such as, for example, to facilitate removal of the wrapping from the meat product. Various net patterns also may be used and can be weaved and/or oriented in various ways. Various suppliers of the aforementioned meat product wrapping products exist and are known to those skilled in the art. Examples of some such suppliers of suitable wrapping products include, but are not limited to, Vista, Cryovac, Jif-Pak, Viskase, PCM, Vector, Zip-Net, Kalle, REELpak®, Tipper Tie, etc. In lieu of a wrapping 550, it also may be possible to use an enclosure in the form of a mold, as described herein, in combination with automated loading equipment.

After the piston 530 has been operated to push all of the whole muscle meat portions 401 out of the loading tube 510 and into the wrapping 550, the wrapping 550 may be removed from the loading tube 510 and secured at both ends. Securing the wrapping may be accomplished via a variety of mechanisms, including but not limited to, for example, tying the ends of the wrapping material, for example, with ties, clips, and/or manual tying the ends, for example, in a knot. The mechanism for securing the wrapping may be selected based on the wrapping type, for example. Those having skill in the art would recognize a variety of suitable securing mechanisms and how to choose appropriate securing mechanisms.

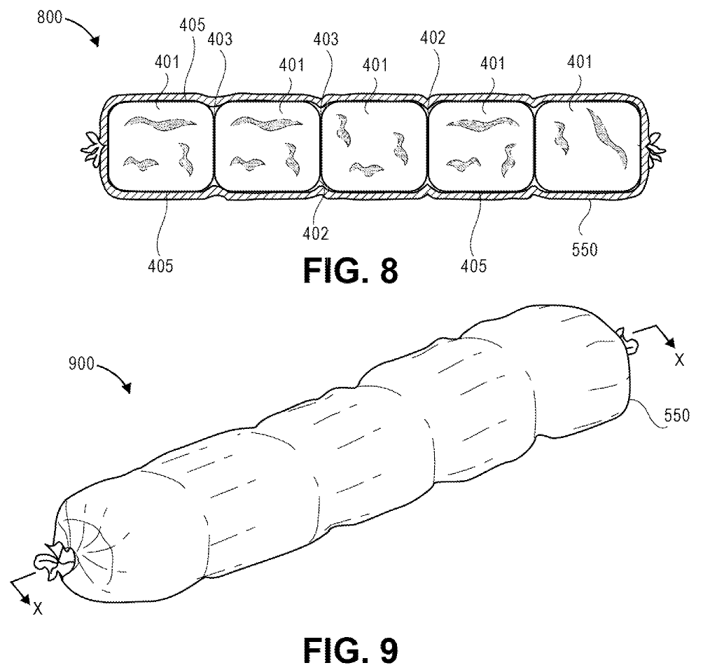

FIG. 8 depicts an exemplary embodiment of the meat product 800 that results from the process described above with reference to FIGS. 5-7. The meat product 800 is a raw or partially cooked meat product. As illustrated, the meat product 800 has the form of a slicing log comprising the plurality of whole muscle meat portions 401 consecutively disposed within the enclosure defined by the wrapping 550. Respective adjacent end faces 402 and 403 of consecutive whole muscle meat portions 401 substantially face one another in the end-to-end arrangement of the meat portions 401 within the enclosure of the wrapping 550.

Achieving a desired positioning of the whole muscle meat portions 401 using the loader 500 and method described with reference to FIGS. 5-7 may depend on selecting an appropriately sized chamber 515, loading tube 510, and enclosure (e.g., wrapping 550 in FIGS. 5-7). More specifically, the sizes of the chamber 515, loading tube 510, and enclosure of the wrapping 550 may be interdependent and selected based on the sizes of the whole muscle meat portions 401 being loaded. For example, the whole muscle meat portions 401 may be roughly similar in size and the width W of the chamber 515, the diameter D of the loading tube 510, and the diameter d of the enclosure defined by the wrapping 550 may be such that any excess space between the lateral surfaces 405 of the meat portions 401 and the interior surfaces of the chamber 515, loading tube 510, and wrapping 550 is limited to substantially inhibit consecutive meat portions 401 from overlapping each other along their respective lateral surfaces 405. In various exemplary embodiments, the chamber width W, the diameter D of the loading tube 510, and the diameter d of the wrapping 550 may be slightly smaller than or about equal to a width dimension of the whole muscle meat portions 401 being loaded. As an example, the chamber width W may be slightly larger than the loading tube diameter D and about equal to a width of the meat portions 401 such that the meat portions 401 are at least slightly compressed laterally upon being loaded into the loading tube 510 and in the enclosure of the wrapping 550. By way of example only, the chamber width W may range from about 2″ to about 10″, the loading tube diameter may range from about 2″ to about 10″, and the wrapping diameter when stuffed with meat may range from about 2″ to about 10″. Moreover, according to various exemplary embodiments, the chamber and loading tube size may be smaller for loading smaller whole muscle meat portions, such as, for example, poultry breast, and larger for loading larger whole muscle meat portions, such as, for example, beef, for example, bottom round beef and/or other similar larger whole muscle meat cuts.

Based on the present teachings, those with skill in the art would be able to select the appropriate combination of chamber size, loading tube size, and enclosure size to obtain a meat product in accordance with exemplary embodiments of the present teachings. The selection of appropriate sizes may depend, for example, on the type of meat being loaded, the size of the whole muscle meat portions being loaded, the desired dimension of slice faces, the desired finish meat product configuration, and other factors known to those skilled in the art.

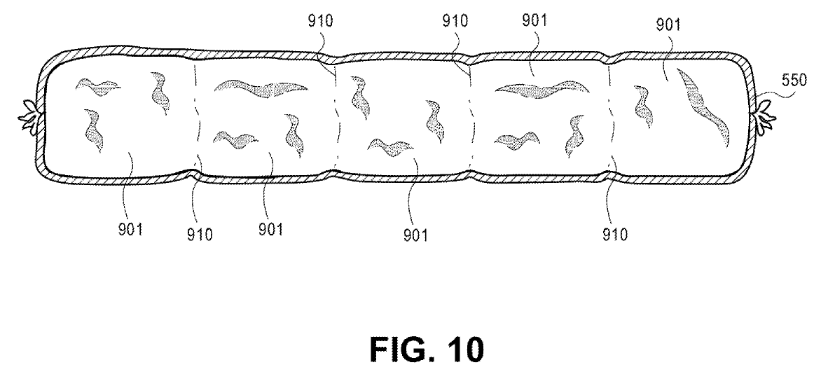

By selecting an appropriately sized chamber 515, loading tube 510, and enclosure (e.g., as defined by wrapping 550), the meat product 800 shown in FIG. 8 may be obtained, with whole muscle meat portions 401 disposed end-to-end and with little or no overlap of the lateral faces 405 of consecutive meat portions 401. The meat product 800, which may be a raw or partially cooked meat product made of fresh or frozen whole muscle meat portions, may then optionally be subjected to a cooking process to yield a meat product 900, as shown in FIGS. 9 and 10, wherein the respective adjacent end faces 402 and 403 of consecutive meat portions attach (e.g., bind) together at least in some regions to form joints 910 and a unitary meat product 900. The cooked meat product 900 is shown in FIGS. 9 and 10 with the wrapping 550, however, the wrapping 550 may be removed prior to slicing. The meat product 900 also may have a slicing yield like that described above with reference to the description of the exemplary embodiment of FIG. 3.

Thus, the process described above permits the formation of a unitary slicing log that yields slices containing meat from single whole muscle meat portions and that may range from about 2 feet to about 5 feet in length, for example, depending on the number and length of the whole muscle meat portions used to form the slicing log. Moreover, the cooked product obtained by the exemplary technique shown and described with reference to FIGS. 5-7, for example, as shown in FIGS. 9 and 10, may have the various characteristics in terms of dimensions and slicing yields as the meat products discussed above in accordance with various exemplary embodiments of the present teachings.

If desired, various cooking processes can be used to cook the raw or partially cooked meat products described herein and the invention is not intended to be limited by any particular cooking process. By way of nonlimiting example only, such cooking processes may include one or more of steaming, smoking (atomized or natural), using dry heat cooking processes, water bath cooking, cooking using step cycles, cooking using non-step cycles, and virtually any other cooking method suitable for cooking meat products. In various exemplary embodiments, the cooking process or combination of cooking processes may be selected based on factors such as, for example, the type of meat, the enclosure in which the meat is cooked, desired finish product yield, desired size of slice face, and/or other factors skilled artisans would understand to take into consideration when selecting a cooking process. Suitable temperature ranges may be selected based on factors, such as, for example, the cooking method, the type of meat being cooked, and other factors known to those skilled in the art to yield a desired finished meat product. As with the cooking process, a variety of ovens, including, for example, those manufactured by Alkar-RapidPak, Inc. or Fessman Wilhelm GmbH of Germany may be used. It should be understood that the invention is not limited by any particular oven type.

Regardless of the cooking process used, application of heat to the raw or partially cooked meat product during cooking may relax the muscle of each of the whole muscle meat portions. Such relaxation may facilitate and/or enhance attaching of the whole muscle meat portions together, for example, by permitting portions of the meat of adjacent end faces of consecutively disposed whole muscle meat portions to fill voids between the whole muscle meat portions and/or by permitting portions of each whole muscle meat portion to fill voids between the whole muscle meat portions and the enclosure interior surface. Thus, the cooking process may also yield a meat product with improved consistency in terms of, for example, slice dimensions and/or other aesthetic features.

In accordance with various exemplary embodiments, it also may be desirable to pretreat the individual whole muscle meat portions prior to loading them into an enclosure and cooking them. Those skilled in the art are familiar with a variety of pretreating processes for sliceable meat products. Such pretreatment processes include, but are not limited to, one or more of marinating, injection marinating, seasoning, vacuum tumbling, mixing, massaging, tenderizing (e.g., needle or hammer style), macerating, preheating, precooking, and/or other pretreatment processes and combinations thereof. Marinating mixtures may include natural or organic substances, such as, for example, mixtures comprising sea salt, mixtures comprising cane sugar, mixtures including starter cultures, and/or other natural or organic brining mixtures, and/or combinations thereof. Marinating mixtures also may include other brines and marinating mixtures, including, for example, mixtures containing binders and/or extenders. Suitable marinating mixtures may encompass both cured and non-cured marinating mixtures. A variety of marinating, brining, and/or seasoning mixtures known to those skilled in the art or obtained by obvious experiment may be used and are considered within the scope of the invention. In exemplary embodiments, the whole muscle meat portions used to form meat products in accordance with the present teachings may contain from 0% to about 60% by weight of raw meat of a marinating mixture.

Subjecting the whole muscle meat portions to one or more of the various pretreatment processes described above may facilitate protein bonds in the whole muscle meat portions to break apart. By breaking apart the protein bonds, those bonds may be configured to reattach during the cooking process used in accordance with the present teachings, thereby facilitating protein bonds of respective adjacent end faces of consecutively disposed whole muscle meat portions to attach (e.g., fuse or bind) to each other and cause at least some regions of those respective adjacent end faces to attach together, as has been described herein. It may be desirable therefore to perform various pretreatment processes on the raw whole muscle meat portions to achieve desired levels of breakage of the protein bonds to thereby optimize fusing of respective adjacent end faces of consecutive whole muscle meat portions during the cooking process, while obtaining a cooked meat product that is desirable in texture and taste.

FIGS. 5-7 depict an exemplary method for forming a meat product in accordance with the present teachings that relies on an automated loader and an enclosure defined by a wrapping. It should be understood, however, that other techniques for making meat products in accordance with the present teachings may be utilized and are contemplated as being within the scope of the invention. For example, the whole muscle meat portions may be manually loaded and positioned in an end-to-end manner into an enclosure as described herein. Also, various other configurations of loading equipment may be used, including a variety of meat presses, loaders, wrappings, etc. known to those skilled in the art, as have been described above and are available through a variety of manufacturers. However, modifications of such loading equipment and the use of such equipment in accordance with the present teachings may be required to obtain a meat product according to various exemplary embodiments described herein. For example, modifications of the various sizes of chambers, loading tubes, and/or wrappings may be needed to select appropriate sizes to achieve end-to-end loading of the whole muscle meat portions, as has been described herein.

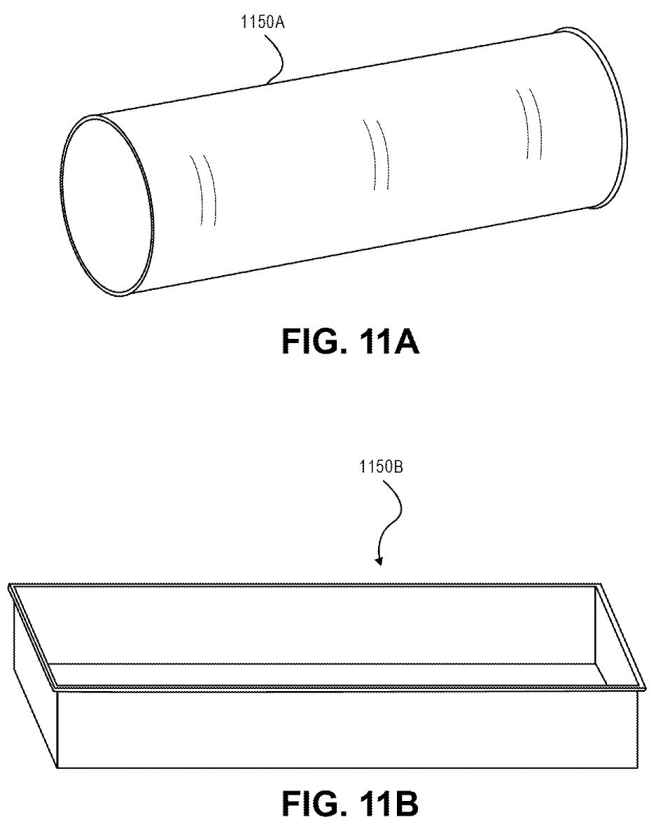

The enclosure into which the whole muscle meat portions are loaded can be defined by a variety of structures other than wrappings, including, for example, a mold 1150A as depicted schematically in FIG. 11A, a mold 11508 as depicted schematically in FIG. 11B, and/or a variety of other types of structures configured to provide sufficient pressure on the free ends of the respective first and last consecutively disposed whole muscle meat portions and on lateral surfaces of the whole muscle meat portions to maintain the whole muscle meat portions in their end-to-end arrangement with respective adjacent end faces substantially facing each other. Such molds may be made from stainless steel and/or any other suitable material configured to transfer heat to the raw meat positioned therein, suitable to be used for food contact, and able to provide sufficient force on the exterior of the whole muscle meat portions to maintain the end-to-end contact of adjacent meat portions. Such molds may be made of a material that is cleanable for re-use or disposable. Suitable molds systems may include a plurality of individual molds provided together, such as, for example, molding systems marketed by Armor Inox. or as described in U.S. Patent Application Publication No. 2005/0172828 A1, which published on Aug. 11, 2005 and is entitled “STACKING UNIT COMPRISING AT LEAST ONE CHAMBER FOR HOUSING A FOOD PRODUCT SUCH AS HAM,” which is incorporated by reference herein in its entirety.

Those skilled in the art would recognize that the exemplary embodiments shown and described herein are illustrative, and the meat products are depicted schematically. Various dimensions, sizes, and configurations, therefore, are not intended to be to scale, but rather to show general features of exemplary embodiments to assist in understanding the invention. Further, those skilled in the art would understand that various modifications to the embodiments disclosed herein may be made, including, for example, modifications to sizes, materials, configurations, and other parameters, without departing from the scope of the present teachings. By way of example only, each of the plurality of whole muscle meat portions used to form meat products in accordance with various exemplary embodiments of the present teachings may be the same type of meat, or, alternatively, at least some of the plurality of whole muscle meat portions may be differing types of meat. Thus, it is envisioned that a meat product could contain whole muscle meat portions of more than one meat type, such as, for example, a whole muscle meat portion made of bovine and a whole muscle meat portion made of poultry.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “less than 10” includes any and all subranges between (and including) the minimum value of zero and the maximum value of 10, that is, any and all subranges having a minimum value of equal to or greater than zero and a maximum value of equal to or less than 10, e.g., 1 to 5.

It is noted that, as used in this specification and the appended claims, the singular forms “a,” “an,” and “the,” include plural referents unless expressly and unequivocally limited to one referent. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to the devices, systems, and methods of the present disclosure without departing from the scope of its teachings. Other embodiments of the disclosure will be apparent to those skilled in the art from consideration of the specification and practice of the teachings disclosed herein. It is intended that the specification and examples be considered exemplary only.

1. A meat product, comprising:
a plurality of whole meat portions, each whole muscle meat portion having substantially opposite end faces,
wherein the plurality of whole muscle meat portions are consecutively disposed such that respective adjacent end faces of the whole muscle meat portions substantially face each other and have at least some regions that are attached, and
wherein the meat product has a substantially elongated configuration in a direction extending from a whole muscle meat portion of the consecutively disposed whole muscle meat portions to a last whole muscle meat portion of the consecutively disposed whole muscle meat portions.

2. The meat product of claim 1, wherein the meat product comprises a cooked meat product.

3. The meat product of claim 1, wherein the meat product is configured such that not more than about 20% of slices obtained from slicing the meat product in a direction substantially perpendicular to a direction of elongation of the meat product contains meat from more than one of the plurality of whole muscle meat portions.

4. The meat product of claim 1, wherein the meat product is configured such that from about 10% to about 15% of slices obtained from slicing the meat product in a direction substantially perpendicular to a direction of elongation of the meat product contains meat from more than one of the plurality of whole muscle meat portions.

5. The meat product of claim 1, wherein the meat product is configured such that at least about 90% of the meat product yields substantially uniformly thick slices when sliced in a direction substantially perpendicular to a direction of elongation of the meat product.

6. The meat product of claim 1, wherein the meat product is formed from a plurality of raw or partially cooked whole muscle meat portions consecutively loaded into an enclosure.

7. The meat product of claim 6, wherein the meat product is formed from a plurality of raw or partially cooked whole muscle meat portions consecutively loaded into an enclosure defined by at least one of a wrapping and a mold.

8. The meat product of claim 1, wherein the plurality of whole muscle meat portions are attached so as to form a unitary product.

9. The meat product of claim 1, wherein the meat product has a length of greater than about 1.5 feet.

10. A method of making a meat product, the method comprising:
consecutively loading a plurality of whole muscle meat portions into an enclosure such that respective adjacent end faces of the whole muscle meat portions substantially face each other,
wherein loading the plurality of whole muscle meat portions into the enclosure forms a meat product having a substantially elongated configuration in a direction extending from a whole muscle meat portion of the plurality of whole muscle meat portions to a last whole muscle meat portion of the plurality of whole muscle meat portions.

11. The method of claim 10, wherein the loading comprises loading the plurality of whole muscle meat portions via loading equipment.

12. The method of claim 11, wherein the loading comprises loading the plurality of whole muscle meat portions via loading equipment comprising a piston configured to advance the whole muscle meat portions into the enclosure.

13. The method of claim 11, further comprising placing at least two whole muscle meat portions into a chamber of the loading equipment simultaneously.

14. The method of claim 11, further comprising advancing the plurality of whole muscle meat portions along a loading tube of the loading equipment.

15. The method of claim 14, further comprising selecting the loading tube from a plurality of loading tubes, wherein the loading tube is selected based on a size of the whole muscle meat portions.

16. The method of claim 14, wherein advancing the plurality of whole muscle meat portions along a loading tube comprises advancing the plurality of whole muscle meat portions along a loading tube configured to substantially prevent consecutive whole muscle meat portions from overlapping each other.

17. The method of claim 16, further comprising selecting the enclosure from a plurality of enclosures, wherein the enclosure is selected based on a size of the whole muscle meat portions.

18. The method of claim 10, further comprising selecting the enclosure from a plurality of enclosures, wherein the enclosure is selected based on a size of the whole muscle meat portions.

19. The method of claim 10, wherein loading the plurality of whole muscle meat portions comprises loading the plurality of whole muscle meat portions into an enclosure configured to substantially prevent consecutive whole muscle meat portions from overlapping each other within the enclosure.

20. The method of claim 10, further comprising cooking the plurality of whole muscle meat portions loaded into the enclosure.

21. The method of claim 10, further comprising forming a slicing log from the plurality of whole muscle meat portions.

22. The method of claim 21, wherein forming the slicing log comprises forming a slicing log configured such that not more than about 20% of slices obtained from slicing the log in a direction substantially perpendicular to an elongated direction of the meat product contain meat from more than one of the plurality of whole muscle meat portions.

23. The method of claim 21, wherein forming the slicing log comprises forming a slicing log such that at least about 90% of the meat product yields substantially uniformly thick slices when sliced in a direction substantially perpendicular to a direction of elongation of the meat product.

24. The method of claim 21, wherein forming the slicing log comprises forming a slicing log having a length of greater than about 1.5 feet.

25. The method of claim 10, wherein consecutively loading the plurality of whole muscle meat portions comprises consecutively loading the plurality of whole muscle meat portions into an enclosure chosen from at least one of a wrapping and a mold.

26. A meat product, comprising:
a whole muscle meat slicing log, wherein the whole muscle meat slicing log is configured to yield at least about 90% of meat slicing having substantially uniform thickness.

27. The meat product of claim 26, wherein the whole muscle meat slicing log comprises a plurality of whole meat portions.

28. The meat product of claim 26, wherein the whole muscle meat slicing log is configured to be sliced in a direction substantially perpendicular to a direction of elongation of the log, and wherein the slicing log is configured such that not more than about 20% of the slices obtained from the log contain meat from more than one of the plurality of whole muscle meat portions.

29. The meat product of claim 26, wherein the whole muscle meat slicing log has a length of greater than about 1.5 feet.

30. A meat product made by a process comprising:
loading consecutively more than one whole muscle meat portions into an enclosure; and
positioning the whole muscle meat portions so that respective adjacent end faces of the whole muscle meat portions substantially face each other thereby forming the meat product to have a substantially elongated configuration in a direction extending from a first whole muscle meat portion of the plurality of whole muscle meat portions to a last whole muscle meat portion of the more than one whole muscle meat portions.

31. The meat product made by the process of claim 30, wherein the loading comprises loading the more than one plurality of whole muscle meat portions via loading equipment.

32. The meat product made by the process of claim 31, wherein the loading comprises loading the more than one whole muscle meat portions via loading equipment comprising a piston configured to advance the whole muscle meat portions into the enclosure.

33. The meat product made by the process of claim 31, further comprising placing at least two whole muscle meat portions into a chamber of the loading equipment simultaneously.

34. The meat product made by the process of claim 31, further comprising advancing the plurality of whole muscle meat portions along a loading tube of the loading equipment.

35. The meat product made by the process of claim 34, further comprising selecting the loading tube from more than one loading tubes, wherein the loading tube is selected based on a size of the whole muscle meat portions.

36. The meat product made by the process of claim 34, wherein advancing the plurality of whole muscle meat portions along a loading tube comprises advancing the plurality of whole muscle meat portions along a loading tube configured to substantially prevent consecutive whole muscle meat portions from overlapping each other.

37. The meat product made by the process of claim 36, further comprising selecting the enclosure from more than one enclosures, wherein the enclosure is selected based on a size of the whole muscle meat portions.

38. The meat product made by the process of claim 30, further comprising selecting the enclosure from more than one enclosures, wherein the enclosure is selected based on a size of the whole muscle meat portions.

39. The meat product made by the process of claim 30, wherein loading the more than one whole muscle meat portions comprises loading the more than one whole muscle meat portions into an enclosure configured to substantially prevent consecutive whole muscle meat portions from overlapping each other within the enclosure.

40. The meat product made by the process of claim 30, further comprising cooking the more than one whole muscle meat portions loaded into the enclosure.

41. The meat product made by the process of claim 30, further comprising forming a slicing log from the more than one whole muscle meat portions.

42. The meat product made by the process of claim 31, wherein forming the slicing log comprises forming a slicing log configured such that not more than about 20% of slices obtained from slicing the log in a direction substantially perpendicular to an elongated direction of the meat product contain meat from more than one of the plurality of whole muscle meat portions.

43. The meat product made by the process of claim 31, wherein forming the slicing log comprises forming a slicing log such that at least about 90% of the meat product yields substantially uniformly thick slices when sliced in a direction substantially perpendicular to a direction of elongation of the meat product.

44. The meat product made by the process of claim 31, wherein forming the slicing log comprises forming a slicing log having a length of greater than about 1.5 feet.

45. The meat product made by the process of claim 30, wherein consecutively loading the more than one whole muscle meat portions comprises consecutively loading the plurality of whole muscle meat portions into an enclosure chosen from at least one of a wrapping and a mold.

46. A system for making a meat product, the system comprising:
a means for consecutively loading more than one whole muscle meat portions into an enclosure such that respective adjacent end faces of the whole muscle meat portions substantially face each other; and
a means for positioning the more than one whole muscle meat portions into the enclosure to form a meat product having a substantially elongated configuration in a direction extending from a whole muscle meat portion of the plurality of whole muscle meat portions to a last whole muscle meat portion of the plurality of whole muscle meat portions.

47. The system of claim 46, wherein the means for loading comprises loading the plurality of whole muscle meat portions is accomplished at least in part by using loading equipment.

48. The system of claim 47, wherein the means for loading comprises a means for loading the more than one whole muscle meat portions via loading equipment which comprises a piston configured to advance the whole muscle meat portions into the enclosure.

49. The system of claim 47, further comprising a means for placing at least two whole muscle meat portions into a chamber of the loading equipment simultaneously.

50. The system of claim 47, further comprising a means for advancing the more than one whole muscle meat portions along a loading tube of the loading equipment.

51. The system of claim 50, further comprising a means for selecting the loading tube from more than one of loading tubes, wherein the loading tube is selected based on a size of the whole muscle meat portions.

52. The system of claim 50, wherein a means for advancing the more than one whole muscle meat portions along a loading tube comprises a means for advancing the plurality of whole muscle meat portions along the loading tube configured to substantially prevent consecutive whole muscle meat portions from overlapping each other.

53. The system of claim 52, further comprising a means for selecting the enclosure from more than one enclosures, wherein the enclosure is selected based on a size of the whole muscle meat portions.

54. The system of claim 46, further comprising a means for selecting the enclosure from more than one enclosures, wherein the enclosure is selected based on a size of the whole muscle meat portions.

55. The system of claim 46, wherein the means for loading the more than one whole muscle meat portions uses a means for loading the more than one whole muscle meat portions into an enclosure that is configured to substantially prevent consecutive whole muscle meat portions from overlapping each other within the enclosure.

56. The system of claim 46, further comprising a means for cooking the more than one of whole muscle meat portions loaded into the enclosure.

57. The system of claim 46, further comprising a means for forming a slicing log from the more than one whole muscle meat portions.

58. The system of claim 57, wherein the means for forming the slicing log comprises a means for forming a slicing log configured such that not more than about 20% of slices obtained from slicing the log in a direction substantially perpendicular to an elongated direction of the meat product contain meat from more than one of the plurality of whole muscle meat portions.

59. The system of claim 57, wherein the means for forming the slicing log comprises a means for forming a slicing log that is configured such that at least about 90% of the meat product yields substantially uniformly thick slices when sliced in a direction substantially perpendicular to a direction of elongation of the meat product.

60. The system of claim 57, wherein the means for forming the slicing log comprises a means for forming a slicing log having a length of greater than about 1.5 feet.

61. The system of claim 46, wherein the means for loading the more than one whole muscle meat portions comprises a means for consecutively loading the plurality of whole muscle meat portions into an enclosure chosen from at least one of a wrapping and a mold.
